(19) United States
(12) Patent Application Publication
(10) Pub. No.: US 2010/0167633 A1
(43) Pub. Date: Jul. 1, 2010

(54) PROTECTIVE DEVICE

(76) Inventors: Ulrich Mueller-Boysen, Esslingen (DE); Cornelius Boeck, Kirchheim (DE); Joachim Schadow, Leinfelder-Echterdingen (DE); Juergen Wiker, Hangzhou/Bing Jiang District (CN); Siegfried Keusch, Deizisau (DE); Markus Meier, Deizisau (DE)

Correspondence Address: MICHAEL J. STRIKER, 103 EAST NECK ROAD, HUNTINGTON, NY, 11743, US

(21) Appl. No.: 12/377,657

(22) PCT Filed: Sep. 7, 2007
(86) PCT No.: PCT/EP07/59404

§ 371 Date: Feb. 16, 2009

(30) Foreign Application Priority Data
Oct. 23, 2006 (DE) 10 2006 049 826.7

(51) Int. Cl. B24B 55/05; B23Q 11/06

(52) U.S. Cl. 451/451

(57) ABSTRACT

The invention originates from a safety device, in particular for hand-held power tools, with a disk-shaped and rotating tool, and with a base body (12). It is recommended that the safety device include an energy-absorbing element (14) arranged on the base body (12).

### BACKGROUND INFORMATION

The present invention is directed to a safety device according to the preamble of claim 1.

Safety devices, in particular for hand-held power tools having a disk-shaped and rotating tool, which include a base body have already been proposed.

### ADVANTAGES OF THE INVENTION

The present invention is directed to a safety device, in particular for hand-held power tools including a disk-shaped and rotating tool, which includes a base body.

It is provided that the safety device includes an energy absorbing element which is situated on the base body, thereby making it possible to advantageously prevent the risk of injury to an operator of the hand-held power tool. Using the energy absorbing element, a buffer zone on the base body may be advantageously attained, thereby advantageously protecting the base body. The base body is preferably located around a disk-shaped and rotating tool of a hand-held power tool, e.g. an angle grinder, thereby making it possible, during operation, for the energy absorption element to advantageously halt sparks and/or material particles and/or, in particular, fragments—which are rotating and/or which have been accelerated outwardly with great force—of a disk which has burst during operation, e.g. a grinding wheel, a cutoff wheel, etc., and to reduce an energy, in particular a kinetic energy of the particles. In this context, an “energy absorption element” is understood to be an element which, due to its material properties, may absorb energy particularly well, in particular kinetic energy, such as rotational energy, translational energy, heat, etc., of parts which come in contact with the energy absorption element. Preferably, a material of the energy absorption element is composed at least partially and preferably completely of a softer material than that of the base body, the energy absorbing element being capable of absorbing energy via an elastic and/or plastic deformability. It is also basically possible, however, for the energy absorption element to be formed of a harder material than that of the base body, thereby making it possible to attain a particularly advantageous stability of the safety device. The energy absorption element also preferably has a thickness in at least one region that is greater than that of the base body.

It is also provided that the energy absorption element is composed of a foam, thereby making it possible to attain a particularly lightweight energy absorption element having particularly good energy absorption properties. A “foam” refers, in particular, to a solid which contains gaseous inclusions, such as gaseous bubbles in particular. The portion of the solid in the foam is preferably limited to walls between the gaseous inclusions. Foam is particularly easy to manufacture in any shape, thereby making it possible to situate it on the base body unit as a layer, an edge, etc. Foam also has a sound-absorbing effect, thereby also making it possible to advantageously reduce noises produced by the hand-held power tool. Further energy-absorbing elements that appear reasonable to one skilled in the art are also feasible, however.

A particularly stable energy absorption element and, therefore, a particularly stable safety device may be advantageously attained when the foam is a metal foam. In addition, metal foams may be manufactured in a cost-effective manner with a simple design. This may be attained in a particularly advantageous manner when the metal foam is a steel foam. Further foams, e.g, carbon foam, etc., that appear reasonable to one skilled in the art are also feasible, however.

It is also provided that the metal foam is a light-metal foam, thereby making it possible to attain a particularly lightweight and stable energy absorption element and, therefore, a particularly lightweight safety device.

A light-metal foam which is also particularly cost-effective and which may be manufactured using a simple design may be attained, thereby advantageously saving high production costs in particular when the light-metal foam is an aluminum foam.

The energy absorption element advantageously has an open-pored design, thereby making it possible via simple design means to halt sparks and/or outwardly-slung material particles which are produced during a cutting and/or grinding procedure, and to at least reduce a further scattering of sparks and/or material particles.

In a further embodiment of the present invention it is provided that the safety device includes a carrier element which is undetachably connected to the energy absorption element. The energy absorption element may be fastened to the carrier element in a particularly stable and fixed manner, thereby making it possible to prevent the energy absorption element from becoming detached from the carrier element, in particular when it absorbs high-energy impacts. “Undetachably connected” is understood to mean a permanent connection, such as a bonded connection, and/or any other type of form-fit, non-positive, and/or integral connections that appear reasonable to one skilled in the art, the connection being designed in a manner such that it is inseparable by an operator during normal use of the safety device. Particularly advantageously, the carrier element is designed as a single piece with the energy absorption element.

It is furthermore provided that the carrier element is undetachably connected to the base body, thereby making it possible to attain a permanent and particularly stable attachment of the carrier element. The carrier element is preferably connected to the base body via a bending method, a welding method, a rolling method, and/or any other type of form-fit, non-positive, and/or integral connection.

The energy absorption element is preferably designed as an edge, thereby making it possible to limit the energy absorption element to a region which is preferably impacted by sparks, material particles, etc., during operation of the hand-held power tool. The energy absorption element, which is designed as an edge, preferably extends to a region of the edge of the base body, a thickness of the edge being advantageously selected to accommodate a maximum expected energy impact due to a part which is absorbed by the energy absorption element.

It is also provided that the energy absorption element is tailored to an edge of the base body, thereby making it possible to attain a particularly stable design of the energy absorption element on the base body, since the base body provides additional support for the energy absorption element. The energy absorption element is preferably located on an inner side of the edge of the base body. An “edge of the base body” is understood to mean a subregion of the base body which is oriented parallel to a thickness of a tool, in particular a sanding disk or a cutoff wheel, and which is located on the base body in the circumferential direction around the tool.

It is also provided that the energy absorption element, together with the base body, extends around an angular range of a tool of 180°, thereby making it possible to attain a particularly advantageous shield—for an operator of a hand-held power tool which includes the safety device—against sparks, material particles, and/or fragments of a burst disk which move radially outwardly with high energy.

It is also provided that a foamable aluminum alloy is plated onto a carrier element, thereby resulting in a stable connection between the carrier element and the aluminum alloy before the aluminum alloy is foamed. The foamable aluminum alloy is preferably plated onto the carrier element in a strip form, it being possible to plate several short strips of the aluminum alloy or one continuous strip of the aluminum alloy onto the carrier element. In this context, “plated on” is understood to mean, in particular, an application of a metal layer, in particular an aluminum alloy, onto the carrier element, thereby resulting in an lindatachable connection between the metal layer and the carrier element. The undetachable connection between the metal layer and the carrier element may be created via mechanical plating, welding, immersion, an electroplating method, and/or any other type of method which appears reasonable to one skilled in the art.

### BRIEF DESCRIPTION OF THE DRAWINGS

Further advantages result from the description of the drawing that follows. An exemplary embodiment of the present invention is shown in the drawing. The drawing, the description, and the claims contain numerous features in combination. One skilled in the art will also advantageously consider the features individually and combine them to form further reasonable combinations.

FIG. 1 shows a safety device according to the present invention, in a sectional view,

FIG. 2 shows a cross-sectional view of the safety device in FIG. 1, along the line II-II,

FIG. 3 shows a composite strip with a carrier element and a foamable aluminum alloy, in a top view, and

FIG. 4 shows the composite strip in FIG. 3, in a cross-sectional view along the line IV-IV.

### DETAILED DESCRIPTION OF THE EXEMPLARY EMBODIMENT

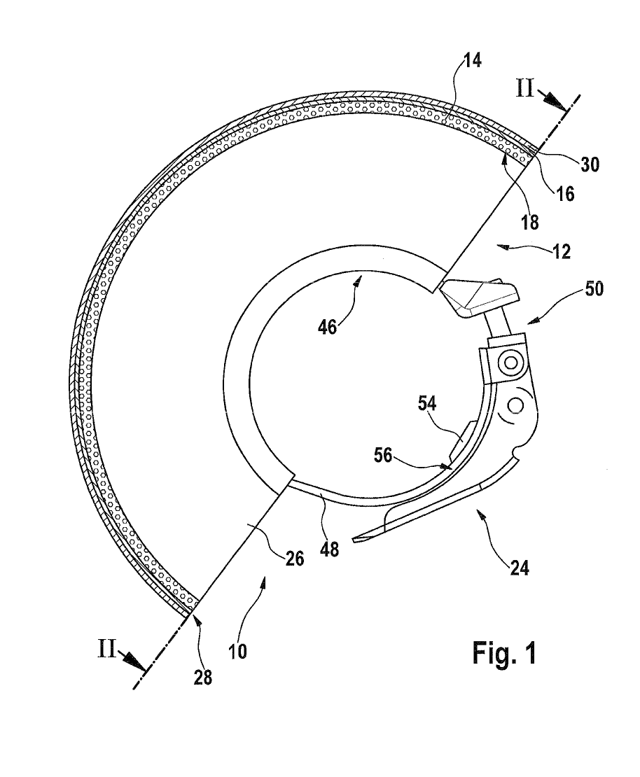

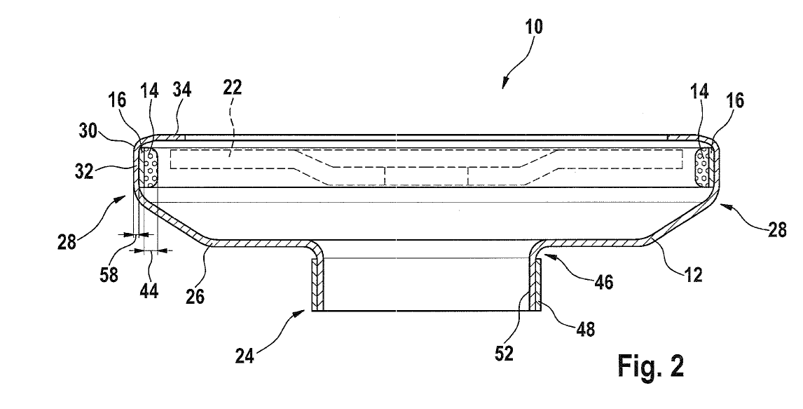

FIG. 1 shows a cross-sectional view of a safety device 10 according to the present invention, i.e. a guard which is provided for a hand-held power tool (not depicted), such as an angle grinder, which includes a disk-shaped and rotating tool 22 (FIG. 2). Safety device 10 includes a base body 12 and a fastening unit 24.

Base body 12 is provided to protect an operator of the hand-held power tool from sparks and/or material particles which are produced during operation of the hand-held power tool. For this purpose, base body 12 is formed by a plate-shaped steel sheet 26 having a semicircular design, plate-shaped steel sheet 26 extending around an angular range of 180° of a tool 22 (FIG. 1). Other materials which have adequate stiffness and hardness, e.g. a carbon fiber design, that appear reasonable to one skilled in the art are also feasible for use to form base body 12.

On a radially outwardly oriented edge region 28 of plate-shaped steel sheet 26, a protective edge 30 which is designed as an edge is located on base body 12, protective edge 30 being oriented initially perpendicularly to plate-shaped steel sheet 26 (FIG. 2). A subregion 32 of protective edge 30 which is oriented perpendicularly to plate-shaped steel sheet 26 is abutted perpendicularly by a further subregion 34 of protective edge 30, subregion 34 being oriented parallel to plate-shaped steel sheet 26 (FIG. 2). Further subregion 34 of protective edge 30 also extends radially inwardly. Subregions 32, 34 of protective edge 30 and plate-shaped steel sheet 26 are manufactured as a single piece using a sheet metal-forming method.

A carrier element 16 with an energy absorption element 14 situated thereon is located between subregions 32, 34 of protective edge 30 and plate-shaped steel sheet 26, along the semicircular shape of steel sheet 26 (FIGS. 1 and 2). Carrier element 16 is formed by a strip of sheet steel, and, along first subregion 32, it is oriented thereon perpendicularly to plate-shaped steel sheet 26 (FIG. 2). On subregion 32 of protective edge 30, carrier element 16 is located on a side which faces the tool. Energy absorption element 14 is composed of a material that is softer than that of steel sheet 26 of base body 12, thereby ensuring effective absorption of sparks and/or material particles by energy absorption element 14. Energy absorption element 14, which is composed of an aluminum foam, extends radially inwardly along carrier element 16.

In a further embodiment of protective device 10 according to the present invention, energy absorption element 14 may also be composed of a material that is harder than that of steel sheet 26 of base body 12, such as a steel foam in particular.

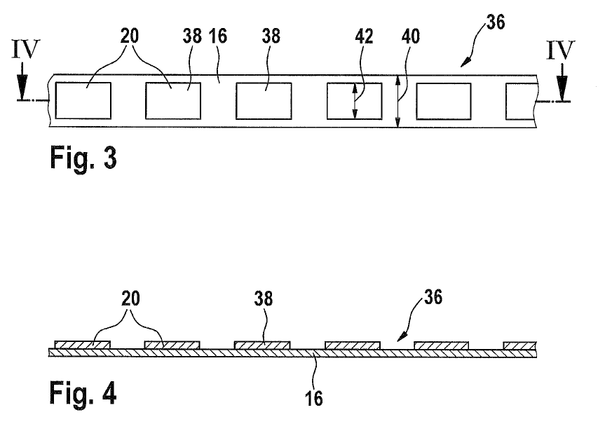

The aluminum foam is foamed onto carrier element 16; the aluminum foam is thereby undetachably connected to carrier element 16. To apply the aluminum foam, a composite strip 36 is produced which includes individual aluminum alloy strips 38 of a pretreated aluminum alloy 20, aluminum alloy strips 38 being plated onto carrier element 16 formed by the strip of sheet steel (FIGS. 3 and 4). Instead of several aluminum alloy strips 38, it is also feasible in a further embodiment of the present invention to plate a continuous aluminum alloy strip 38 onto carrier element 16. A width 40 of carrier element 16 is greater than a width 42 of individual aluminum alloy strips 38. After plating, aluminum alloy strips 38 are foamed, and composite strip 36 is cut into the length required for safety device 10 and is connected to base body 12 or plate-shaped steel sheet 26. For this purpose, carrier element 16 is welded together with plate-shaped steel sheet 26. Other types of connections between carrier element 16 and base body 12 that appear reasonable to one skilled in the art, e.g. riveting, threaded connections, bonding, etc., are also feasible.

Energy absorption element 14 and the aluminum foam have an open-pored design (FIGS. 1 and 2) which is provided to ensure effective absorption of sparks and/or material particles produced during operation of the hand-held power tool by advantageously halting the sparks and/or material particles. Energy absorption element 14 is also designed as an edge 18 which extends along protective edge 30 of base body 12 (FIG. 1). Together with base body 12, energy absorption element 14 extends around an angular range of 180° of a disk-shaped and rotating tool 22 of the hand-held power tool (FIG. 1). A thickness 44 of edge 18 is selected to accommodate a maximum expected energy impact by a fragment of a tool 22, e.g. a disk, that has burst during operation, thereby protecting the operator from harm and, at the least, reducing damage to base body 12. Thickness 44 of energy absorption element 14 is also greater than a thickness 58 of subregion 32 of protective edge 30, thereby ensuring that the latter is also advantageously protected by energy absorption element 14.

Fastening unit 24 is located on base body 12 on a radially inwardly oriented edge region 46 of plate-shaped steel sheet 26 (FIGS. 1 and 2). Fastening unit 24 includes a clamp 48 composed of spring steel, and a clamping unit 50. Clamp 48 is annular in design and is located around a semicircular edge 52 of base body 12. Semicircular edge 52 is perpendicular to plate-shaped steel sheet 26 of base body 12 (FIGS. 1 and 2). Semicircular edge 52 of base body 12 and plate-shaped steel sheet 26 are manufactured as a single piece using a sheet metal-forming method (FIG. 2). Clamp 48 is welded to base body 12. Other connections between clamp 48 and base body 12 which appear reasonable to one skilled in the art are also feasible, such as a connection which is created using a pressure joining method, etc. Annular clamp 48 is clamped with the aid of clamping unit 50 around a receiving region (not depicted) of a hand-held power tool by constricting or expanding a circumference of annular clamp 48 together with clamping unit 50.

Annular clamp 48 also includes, in the region of clamping unit 50, a rib-shaped locking element 54 which extends along subregion 56 of annular clamp 48 (FIG. 1). Rib-shaped locking element 54 is provided to lock safety device 10 in place, thereby ensuring that safety device 10 is non-rotatably situated around a disk-shaped and rotating tool 22 of the hand-held power tool.

What is claimed is:

1. A safety device, in particular for hand-held power tools which include a disk-shaped, rotating tool, and a base body (12), characterized by an energy absorption element (14) which is located on the base body (12).

2. The safety device as recited in claim 1,
wherein
the energy absorption element (14) is at least partially composed of a material that is softer than that of the base body (12).

3. The safety device as recited in claim 1,
wherein
the energy absorption element (14) is at least partially composed of a material that is harder than that of the base body (12).

4. The safety device as recited in claim 1,
wherein
a thickness (44) of the energy absorption element (14) is designed to be at least partially greater than a thickness (58) of the base body (12).

5. The safety device as recited in claim 1,
wherein
the energy absorption element (14) is composed of a foam.

6. The safety device as recited in claim 5,
wherein
the foam is a metal foam.

7. The safety device as recited in claim 6,
wherein
the metal foam is a light metal foam.

8. The safety device as recited in claim 7,
wherein
the light metal foam is an aluminum foam.

9. The safety device as recited in claim 6,
wherein
the metal foam is a steel foam.

10. The safety device as recited in claim 1,
wherein
the energy absorption element (14) has an open-pored design.

11. The safety device as recited in claim 1, characterized by a carrier element (16) which is undetachably connected to the energy absorption element (14).

12. The safety device as recited in claim 11,
wherein
the carrier element (16) is undetachably connected to the base body (12).

13. The safety device as recited in claim 1,
wherein
the energy absorption element (14) is designed as an edge (18).

14. The safety device as recited in claim 13,
wherein
the energy absorption element (14) is tailored to an edge of the base body (12).

15. The safety device as recited in claim 1,
wherein
the energy absorption element (14), together with the base body (12), extends around an angular range of a tool of 180°.

16. A method for manufacturing a safety device as recited in claim 1,
wherein
a foamable aluminum alloy (20) is plated onto a carrier element (16).
